(19) United States
(12) Patent Application Publication
(10) Pub. No.: US 2002/0024942 A1
(43) Pub. Date: Feb. 28, 2002

(54) Cell search method and circuit in W-CDMA system

(75) Inventors: Kiyoshi Tsuneki, Tokyo (JP); Yuichi Maruyama, Tokyo (JP)

Correspondence Address: YOUNG & THOMPSON, 745 SOUTH 23RD STREET 2ND FLOOR, ARLINGTON, VA, 22202

(73) Assignee: NEC Corporation

(21) Appl. No.: 09/939,675

(22) Filed: Aug. 28, 2001

(30) Foreign Application Priority Data
Aug. 30, 2000 (JP) 2000-260608

(51) Int. Cl. H04B 7/216

(52) U.S. Cl. 370/335; 370/342

(57) ABSTRACT

A cell search apparatus and method for performing a cell search without using matched filter are provided. The cell search apparatus includes a correlating unit having a code generator for generating a P-search code in a first step of identifying slot timing, an S-search code in a second step of identifying frame timing and a P-scrambling code in a third step of identifying a scrambling code. The correlating unit executes despread processing utilizing the P-search code in the first step, despread processing utilizing the S-search code in the second step and despread processing using the P-scrambling code in the third step. The cell search circuit further comprises a power calculating unit for calculating correlation power values from the output of the correlating unit, a memory for storing the output of the power calculating unit, a detect unit for searching for a maximum value of correlation power values that have been stored in the memory, a decision unit for comparing an average value of correlation power values that have been stored in the memory with the maximum value, using a predetermined threshold coefficient, in the second and third steps; and a control unit for controlling the operation timing of the above-mentioned units.

### FIELD OF THE INVENTION

This invention relates to a method and apparatus for implementing a cell search in a mobile wireless communications system. More particularly, the invention relates to a cell search method and circuit in W-CDMA (Wideband CDMA) system.

### BACKGROUND OF THE INVENTION

In a wireless communication system adopting a CDMA(Code Division Multiple Access) cellular schema as a multiple access technique for a plurality of mobile terminals, a cell search operation is required at an initial sync establishment(an initial acquisition) in a power on sequence of the mobile terminal or at a time of cell exchange accompanied by a movement of the mobile terminal.

FIG. 7 is a block diagram illustrating an example of the structure of a cell search circuit 2 accommodated in a conventional mobile terminal. The cell search circuit 2 includes a matched filter 23, the input to which is a baseband receive signal (RX). The matched filter 23 is used for executing despread processing only in Step 1 (slot timing identification) of a cell search method in W-CDMA (IMT-2000) FDD mode proposed by the ITU (International Telecommunication Union). In SS (Spread Spectrum) communication, despreadding (inverse-spreading) indicates spread demodulation in a receiver side using the same spread code(PN code) as that of a transmission side. In SS (Spread Spectrum) communications, a matched filter, which performs the initial acquisition, etc., at high speed, comprises plural stages of registers, a plurality of multipliers for multiplying the output of each stage register by a coefficient, and an adder for adding the outputs of the plurality multipliers and outputting the sum. For example, in case of one symbol composed of 256 chips, a 256-stage matched filter is composed of 512 adders and a 512-word register for an I-component (in-phase component) and Q-component (quadrature component).

Despreading in Step 2 (frame timing identification) and Step 3 (scrambling code identification) in the cell search method proposed by the ITU is performed by a correlating unit 21. The correlating unit 21 is used commonly at both Steps 2 and 3. That is, the correlating unit 21 includes a code generator 22 which generates a code for frame timing identification in step 2 and a code for scrambling code identification in step 3, and a correlator in the correlating unit 21 calculates the correlation between the code generated by the code generator 22 and the baseband receive signal.

A selector 24 selectively outputs one of the outputs of the correlating unit 21 and matched filter 23.

A power calculation unit 25, to which the output of selector 24 is input, obtains the sum of the squares of I and Q components to calculate a power(electric power value).

On the assumption that one symbol comprises 256 chips and one slot is constituted by 10 symbols, a memory 26 comprises a 2560-word RAM (Random-Access Memory). The memory 26 is shared in the processing of Steps 1, 2 and 3.

A detect unit 27 searches for a maximum (peak) value among correlation values written to the memory 26 by the matched filter 23 and correlating unit 21.

A decision unit 28 compares the average value stored in memory 26 and the peak value using a threshold coefficient.

A control unit 20, which receives a system counter signal, controls the operation timing of each of the circuit components.

In this arrangement, the matched filter 23 of Step 1 outputs one correlation value chip by chip and finishes calculation at 2560 chips (one slot).

For a description of cell search circuits having a matched filter and correlator, refer to the specifications Japanese Patent Kokai Publication JP-A-11-88295 and Japanese Patent Kokai Publication JPA-10-200447, by way of example.

With the conventional cell search method, definite candidates are narrowed down to one in each of Steps 1 to 3 and processing then advances to the next step. That is, only one candidate is output at Step 1. As a consequence, it is necessary to enhance reliability of the candidate of Step 1 by executing despreading at high speed and performing cumulative addition over several slots and hence the matched filter 23 is required in the conventional cell search circuit, as shown in FIG. 7.

A shortcoming with the conventional cell search circuit using a matched filter is that the matched filter, which is used only in Step 1, results in an increase of circuit scale and the increase in an amount of electric current consumed.

### SUMMARY OF THE INVENTION

Accordingly, it is an object of the present invention to provide a cell search method and apparatus through which the scale of the circuitry and power consumption are reduced by implementing a cell search that does not require use of a matched filter.

The foregoing object is accomplished in accordance with one aspect of the present invention by providing a cell search method in a CDMA mobile communications system which includes a first step of identifying slot timing, a second step of identifying frame timing and a third step of identifying a scrambling code, wherein calculation of correlation values at each step is performed by a correlating unit; the first step of identifying slot timing detects a plurality of candidates for slot timing without narrowing results of slot timing identification down to one candidate, the plurality of candidates for slot timings being detected one slot by detecting one candidate, for which correlation power indicates a peak value, at regular time intervals; the second step of frame timing identification performs frame timing identification with regard to all candidates based upon the plurality of candidates for slot timing, and selects one candidate for frame timing indicating a peak value from among a plurality of candidates for frame timing; and the third step of scrambling code identification obtains correlation power with regard to the one timing candidate selected at the second step, and identification is achieved by rendering a threshold decision.

In accordance with one aspect of the present invention, is provided a cell search apparatus comprising: a correlating unit including: a code generator which generates a P-search code in a first step of identifying slot timing, an S-search code in a second step of identifying frame timing and a P-scrambling code in a third step of identifying a scrambling code; and a plurality of correlators arranged in parallel; said correlating unit executing despread processing utilizing the P-search code in the first step, despread processing utilizing the S-search code in the second step and despread processing using the P-scrambling code in the third step;

a power calculating unit which calculates correlation power from the output of said correlating unit and outputs the calculated correlation power;

a memory which stores the output of said power calculating unit;

a detect unit which searches for a maximum value of correlation powers that have been stored in said memory in each of the first, second and third steps;

a decision unit which compares an average value of correlation powers that have been stored in said memory with the maximum value, using a predetermined threshold coefficient, in the second and third steps; and

a control unit which controls operation timing of each of the said units.

In accordance with another aspect of the present invention, said correlating unit creates a correlation power profile based upon the P-search code in said step 1, a plurality of said correlators arranged in parallel in said correlating unit which respectively execute an operation for starting operation chip by chip while each shifts a despreading position by one chip, executing despreading over the duration of one symbol and outputting the results, said operation being executed successively over one slot comprising a plurality of symbols, and said correlators then halt the operation for the duration of a number of chips equivalent to the number of said plurality of correlators and subsequently execute processing similar to that of the preceding slot in the next slot; said processing is executed over a predetermined plurality of slots, thereby completing despreading at a predetermined number of chip positions, and when calculation of correlation values by said correlating unit and calculation of powers by said power calculating unit end and the correlation powers are written to said memory at all timings of chip positions of the predetermined number, said detect unit starts searching for a maximum value, detects one candidate, which takes on a maximum value, over the duration of one symbol, and detects a plurality of candidates with regard to a plurality of symbols.

In accordance with another aspect of the present invention, at said second step, a correlation power profile based upon the P-search code is created at all timings of the plurality of candidates detected at said step 1, said correlating unit has a plurality (2N) of correlators which operate upon being divided into first and second groups, the correlators in each group operating at identical timings; the correlators of the first group perform despreading respectively by all codes of code numbers 1 to N in order, the correlators of the second group perform despreading respectively by all codes of code numbers 1 to N in order, the correlators of the first group perform despreading of odd-numbered symbols and output the results and the second group of correlators perform despreading of even-numbered symbols and output the results, with despreading being executed over the duration of one symbol; this processing is executed over a prescribed number of slots to thereby complete despreading; and when calculation of correlation values by said correlating unit and calculation of powers by said power calculating unit end and the correlation powers are written to said memory at all timings, said detect unit starts searching for a maximum value and detects one candidate that takes on a maximum value; and said decision unit evaluates the candidate using an average of the power values that have been written to said memory, the maximum value and a predetermined threshold value.

The cell search apparatus in accordance with the present invention, further comprises means for exercising control in such a manner that control shifts to the processing of said third step if the maximum value exceeds (threshold value)×(average value), and processing from said first step is executed if the maximum value does not exceed (threshold value)×(average value).

The cell search apparatus in accordance with the present invention, further comprises means for exercising control in such a manner that if a number of times said first step is restarted exceeds a number of times specified by a predetermined parameter, the cell search is judged to have failed and the cell search is terminated.

The cell search apparatus in accordance with the present invention, further comprises means for exercising control in such a manner that if a number of times said first step is restarted exceeds a number of times specified by a predetermined parameter, the cell search is judged to have failed and the cell search is terminated.

In accordance with the present invention, at said third step, said correlating unit creates a correlation power profile based upon the P-search code at the timing of the one candidate detected at said second step;

when calculation of correlation values by said correlating unit and calculation of powers by said power calculating unit end and the correlation powers are written to said memory, said detect unit starts searching for a maximum value and detects one candidate that takes on a maximum value; and

said decision unit evaluates the one candidate using an average of the power values that have been written to said memory, the maximum value and a predetermined threshold value.

The cell search apparatus in accordance with the present invention, further comprises means for exercising control in such a manner that the cell search ends normally if the maximum value exceeds (threshold value)×(average value) and control returns to said third step if the maximum value does not exceed (threshold value)×(average value).

In the cell search apparatus in accordance with the present invention, said detect unit is adapted to detect a plurality of slot timing candidates over the duration of one symbol in said first step. In the cell search circuit in accordance with the present invention, said detect unit is adapted to detect one slot timing candidate over the duration of a plurality of symbols in said first step and to detect a plurality of candidates in one slot.

Still other objects and advantages of the present invention will become readily apparent to those skilled in this art from the following detailed description, wherein only the preferred embodiment of the invention is shown and described, simply by way of illustration of the best mode contemplated of carrying out this invention. As will be realized, the invention is capable of other and different embodiments, and its several details are capable of modifications in various obvious respects, all without departing from the invention. Accordingly, the drawing and description are to be regarded as illustrative in nature, and not as restrictive.

### BRIEF DESCRIPTION OF THE DRAWINGS

FIG. 1 is a block diagram illustrating the structure of a cell search circuit according to an embodiment of the present invention;

FIG. 2 is a flowchart useful in describing a cell search operation according to this embodiment;

FIG. 3 is a diagram illustrating the operation timing of a correlating unit for creating a correlation power profile based upon a P-search code in this embodiment;

FIG. 4 is a diagram illustrating a method of searching for a peak value performed by a detect unit in this embodiment;

FIG. 5 is a diagram illustrating the operation timing of a correlating unit for creating a correlation power profile based upon an S search code in this embodiment;

FIG. 6 is a diagram illustrating the operation timing of a correlating unit in Step 1 according to a second embodiment of the present invention; and

FIG. 7 is a diagram illustrating the structure of a cell search circuit according to the prior art.

### DESCRIPTION OF THE PREFERRED EMBODIMENTS

Preferred embodiments of the present invention will now be described. The ITU (International Telecommunication Union) has proposed a cell search method in W-CDMA (IMT-2000) FDD (Frequency Division Multiplexing). The method includes a Step 1 (slot timing identification), a Step 2 (frame timing identification) and a Step 3 (scrambling code identification). The present invention has the following features with regard to these steps of the proposed cell search method:

(1) A single detection cycle is adopted for Step 1 (slot timing identification) and Step 2 (frame timing identification).

(2) A plurality of candidates for slot timings are detected without narrowing the results of slot timing identification in Step 1 down to one candidate.

(3) One candidate indicating a maximum value is detected each predetermined time interval from the plurality of candidates for slot timing in Step 1.

(4) In frame timing identification of Step 2, frame timing identification is performed with respect to all candidates based upon the plurality of candidates obtained in Step 1.

(5) One candidate for frame timing indicating a maximum value is selected from among a plurality of candidates for frame timing obtained in Step 2.

(6) A threshold decision is performed to achieve identification with regard to the one candidate for frame timing in Step 2.

(7) In the threshold decision of (6) above, processing is re-executed starting from Step 1 if the threshold decision criterion cannot be satisfied.

By using the cell search algorithm having the features (1) to (7) above, the matched filter, used only in Step 1 in the conventional cell search method, is eliminated, and the correlator used in Steps 2 and 3 is shared to implement Step 1. This makes it possible to reduce the scale of the circuitry and power consumption.

In a preferred embodiment of the present invention, the cell search circuit includes a correlating unit (11) having a code generator (12), which generates a P-search code in a first step of identifying slot timing, an S-search code in a second step of identifying frame timing and a P-scrambling code in a third step of identifying a scrambling code, and a plurality of correlators provided in parallel, correlating unit (11) executing despread processing utilizing P-search code in the first step, despread processing utilizing S-search code in the second step and despread processing using the P-scrambling code in the third step; a power calculating unit (13) for calculating correlation power from the output of the correlating unit and outputting the calculated correlation power; a memory (14) for storing the output of the power calculating unit; a detect unit (15) for detecting a maximum value of correlation powers stored in the memory in each of the above-mentioned steps; a decision unit (16) for comparing an average value of correlation powers stored in the memory with the maximum value, using a predetermined threshold coefficient, in the second and third steps; and a control unit (10) for controlling operation timing of the above-mentioned units.

Preferred embodiments of the present invention will now be described in detail with reference to the accompanying drawings.

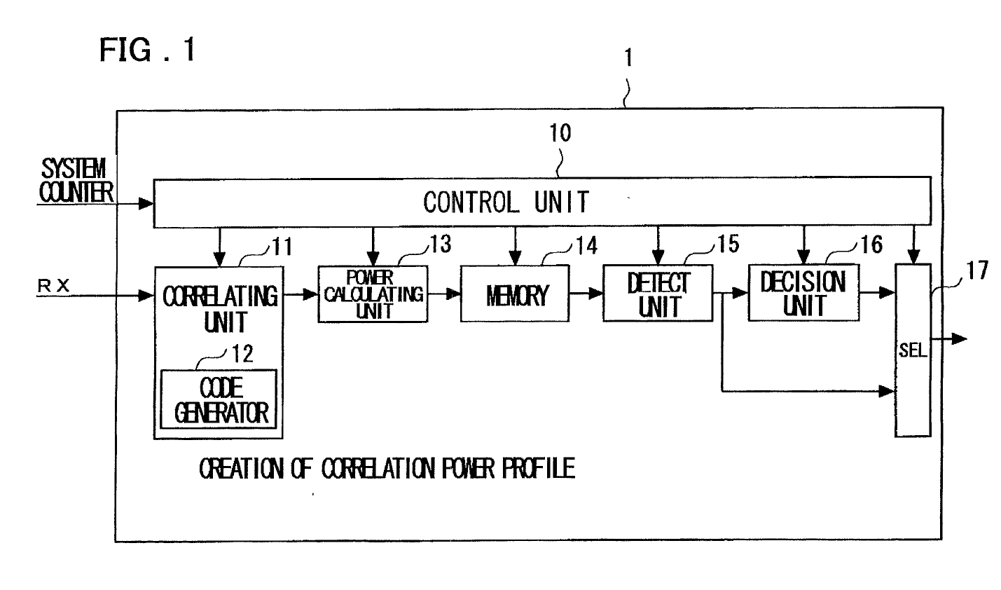

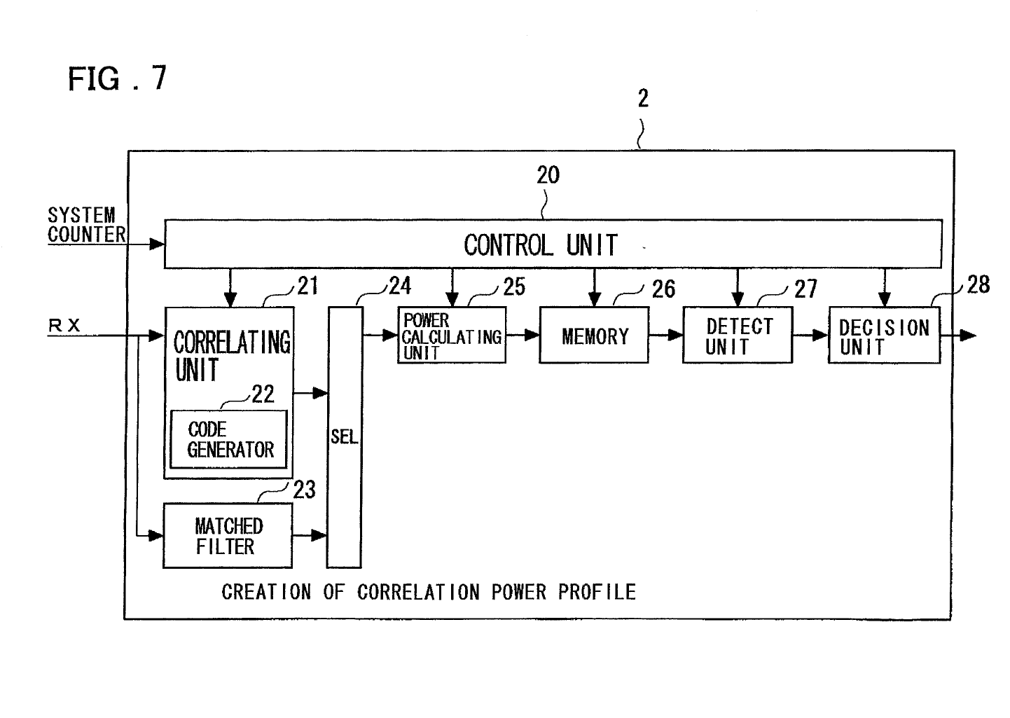

FIG. 1 is a block diagram illustrating the structure of a cell search circuit 1 according to a first embodiment of the present invention. As shown in FIG. 1, the cell search circuit 1 is not provided with a matched filter of the kind shown in FIG. 7 illustrative of the conventional cell search circuit. Here a correlating unit 11, which receives a baseband receive signal (RX), executes Step 1 (identification of slot timing), a Step 2 (identification of frame timing) and a Step 3 (identification of scrambling code).

The correlating unit 11 comprises a code generator 12 for generating a P-search code (first search code; “P” indicates “Pre”) in case of Step 1, an S-search code (second search code; “S” indicates “Secondary”) in case of Step 2 and a P-scrambling code (third search code) in case of Step 3. The P-search code, S-search code and Pscrambling code are codes defined by the 3GPP (Third Generation Partnership Project). Refer to the 3GPP specifications (3G TS 25.231 Chapters 5.22, 5.23).

The correlating unit 11, which has 32 correlators, executes despread processing utilizing the P-search code generated by the code generator 12 in Step 1, despread processing utilizing the S-search code generated by the code generator 12 in Step 2 and despread processing using the P-scrambling code generated by the code generator 12 in Step 3. Thus, the correlating unit 11 is used by being shared in Steps 1, 2 and 3.

A power calculation unit 13, to which the output of the correlating unit 11 is input, calculates the square value of I and Q components.

A memory 14 comprises a RAM (Random-Access Memory) the capacity of which is 2560 words in a case where one symbol is composed of 256 chips and one slot is composed of 10 symbols. The memory 14 is shared for use in Steps 1, 2 and 3.

A detect unit 15 searches for a maximum value based upon correlation values that have been written to the memory 14 by the correlating unit 11.

A decision unit 16 compares the average value stored in the memory 14 and the maximum value using a threshold coefficient. In Step 1, however, processing of the decision unit 16 is omitted. That is, the output of the detect unit 15 is delivered via a selector 17 and is not subjected to processing by the decision unit 16.

A control unit 10, to which a system counter signal is input, controls the operation timing of each of the blocks 11 to 17.

The operation of the cell search circuit 1 according to this embodiment will now be described in detail. It will be assumed that one slot timing candidate in Step 1 is detected on a per-symbol basis, for a total of ten candidates in one slot.

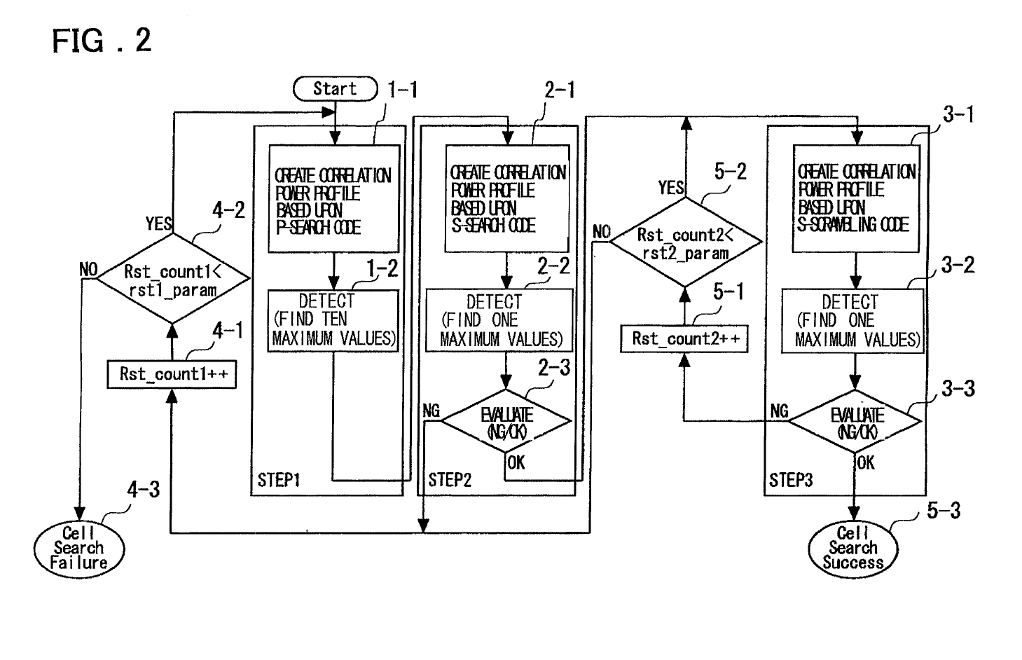

FIG. 2 is a flowchart useful in describing the cell search operation according to this embodiment.

As shown in FIG. 2, the cell search is carried out by three steps, namely steps 1, 2 and 3.

When the cell search operation starts, creation of a correlation power profile begins immediately using the P-search code (step 1-1).

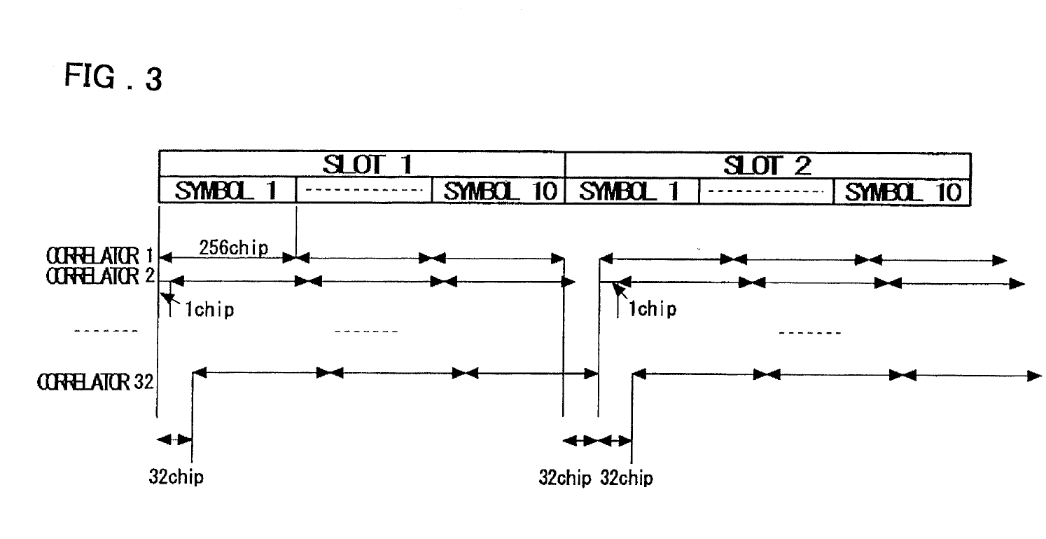

FIG. 3 is a diagram illustrating the operation timing of the correlating unit 11 for creating the correlation power profile.

(1) The 32 parallel correlators 1 to 32 provided in the correlating unit 11 start operating chip by chip while each shifts the despreading position by one chip to thereby execute despreading over the duration of one symbol (256 chips). These results are delivered as the output.

(2) The processing of (1) above is executed successively over the duration of one slot (10 symbols).

(3) Next, after processing is halted for the duration of 32 chips, each of the correlators 1 to 32 performs the same operation (1) again.

(4) The processing of (1) to (3) above is executed over eight slots, thereby completing despreading at 2560 chip positions.

The output (correlation value) of the correlating unit 11 is provided to the power calculating unit 13, which calculates a correlation power by summing the squares of the I and Q components. The calculated correlation power value is written to the memory 14.

When operation of the correlating unit 11 and calculation by the power calculating unit 13 end and the calculated correlation power values have been written to the memory 14 at all timings in one slot (at 2560 chip positions), the detect unit 15 starts the search for the peak value (step 1-2).

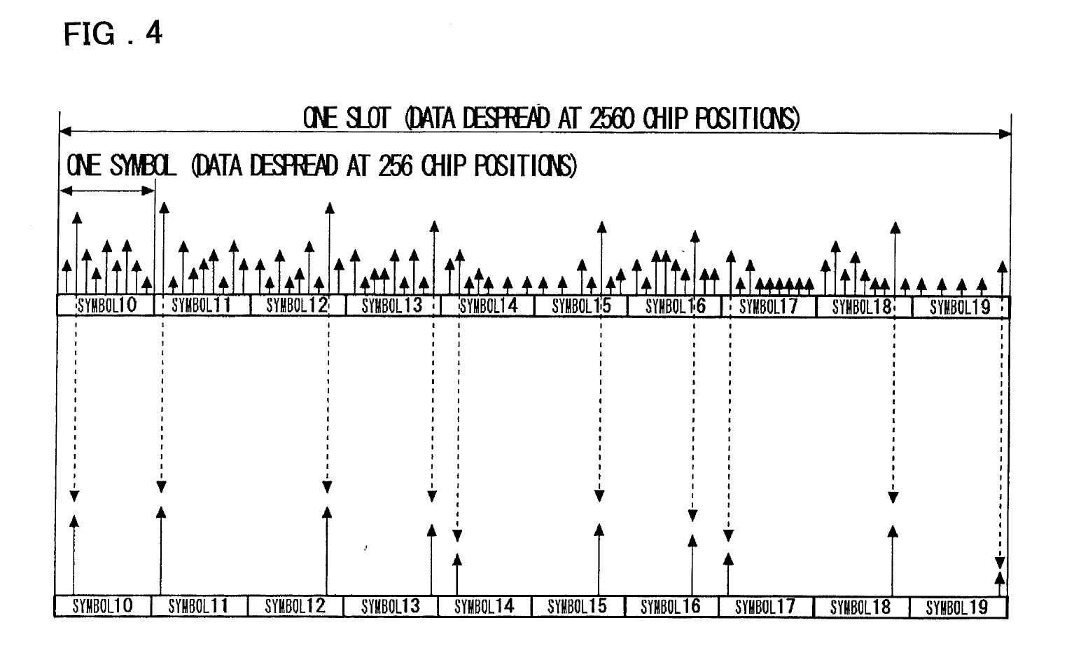

FIG. 4 is a diagram illustrating a method of searching for a maximum value according to this embodiment. The method includes detecting one candidate representing a maximum value over the duration of one symbol (256 chips), and detecting a total of ten candidates with regard to respective ones of ten symbols. This ends the processing of step 1.

Next, in step 2, the correlating unit 11 starts the creation of correlation power profile using the S-search code. This is performed at the timings of all ten candidates detected in step 1.

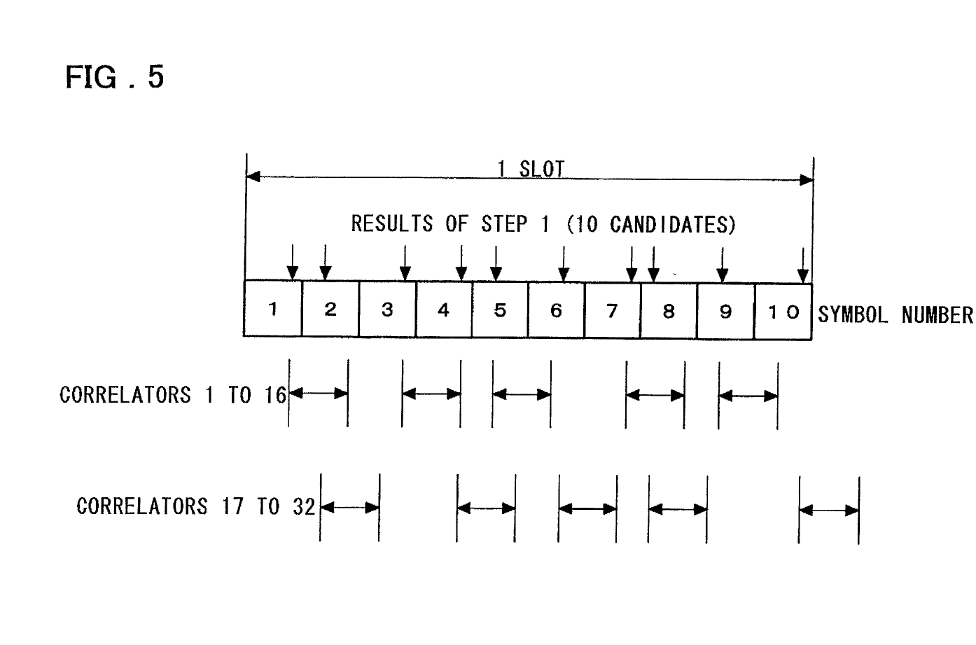

FIG. 5 is a diagram illustrating the operation timing of the correlating unit 11 for creating the correlation power profile in step 2.

As shown in FIG. 5, the 32 correlators in the correlating unit 11 operate upon being divided into two groups, namely correlators 1 to 16 and correlators 17 to 32. Correlators in the same group operate at the same timing.

The first group of correlators 1 to 16 perform despreading by all codes of code numbers 1 to 16 of correlators 1 to 16, respectively.

The second group of correlators 17 to 32 perform despreading by all codes of code numbers 1 to 16 of correlators 17 to 32, respectively.

The first group of correlators 1 to 16 perform despreading of odd-numbered symbols and the second group of correlators 17 to 32 perform despreading of even-numbered symbols, with despreading being executed over the duration of one symbol (256 chips). The correlators output the results of despreading. This processing is executed over 15 slots, whereby despreading is completed.

The output of the correlating unit 11 is fed to the power calculating unit 13, which proceeds to calculate power and to write the power value to the memory 14.

When operation of the correlating unit 11 and calculation by the power calculating unit 13 end and the calculated values have been written to the memory 14 at all timings, the detect unit 15 begins to search for the maximum value and detects one candidate representing a maximum value (step 2-2).

The decision unit 16 evaluates this candidate (step 2-3).

The decision unit 16 makes its decision using the average of the power values, which have been written to the memory 14, the maximum value and a predetermined threshold value.

If the maximum value exceeds (threshold value)×(average value), then control proceeds to step 3.

If the maximum value does not exceed (threshold value)×(average value), then control returns to step 1.

If a restart count (Rst_count1), which is for managing loop counts of step 1, exceeds a number of times (a predetermined set value) specified by a parameter (rst1_param), it is judged that the cell search failed and processing exits.

In other words, if the decision rendered at step 2-3 is NG, namely that the maximum value is not greater than (threshold value)×(average value), then the restart count (Rst_count1) is incremented at step 4-1 and it is determined at step 4-2 whether the restart count (Rst_count1) is smaller than the parameter (rst1_param). If the restart count (Rst_count1) is equal to or greater than the parameter (rst1_param), it is judged that the cell search failed (step 4-3). If the restart count (Rst_count1) is smaller that the parameter (rst1_param), processing is executed from step 1-1 onward.

At step 3, the correlating unit 11 starts the creation of the correlation power profile using the P-scrambling code at the timing of the single candidate detected at step 2.

The output (correlation value) of correlating unit 11 is supplied to the power calculating unit 13, which calculates power and write the calculated value to the memory 14.

When operation of the correlating unit 11 and calculation of power by the power calculating unit 13 end and the calculated values have been written to the memory 14 at all timings, the detect unit 15 starts the search for the maximum value and detects one candidate representing a maximum value (step 3-2).

The decision unit 16 evaluates this candidate (step 3-3). The decision unit 16 makes its decision using the average of the power values that have been written to the memory 14, the maximum value and a predetermined threshold value.

If the maximum value exceeds (threshold value)×(average value), then the cell search finishes normally (step 5-3).

If the maximum value does not exceed (threshold value)×(average value), then control returns to step 3.

If a restart count (Rst_count2), which is for managing the loop count of step 3, is equal to or greater than a number of times specified by a parameter (rst2_param), control returns to step 1. In other words, if the decision rendered at step 3-3 is NG, then the restart count 25 (Rst_count2) is incremented at step 5-1. If the restart count (Rst_count2) is greater than the parameter (rst2_param), control branches to step 4-1. If the restart count (Rst_count2) is smaller than the parameter (rst2_param), processing is executed from step 3-1 onward. The restart count (Rst_countl), which is for managing the loop count of step 1 is repeated, is incremented at step 4-1. If it is found at step 4-2 that the restart count (Rst_count1) is equal to or greater than a number of times specified by the parameter (rst1_param), then it is judged that the cell search failed.

A second embodiment of the present invention will now be described. The basic structure of the second embodiment is similar to that of the first embodiment but the number of slot timing candidates involved in Step 1 differs.

In the second embodiment of the present invention, two timing slot candidates in Step 1 are detected on a per-symbol basis, for a total of 20 candidates. In the second embodiment, the correlating unit has twice the number of correlators as the correlating unit 11 of the first embodiment.

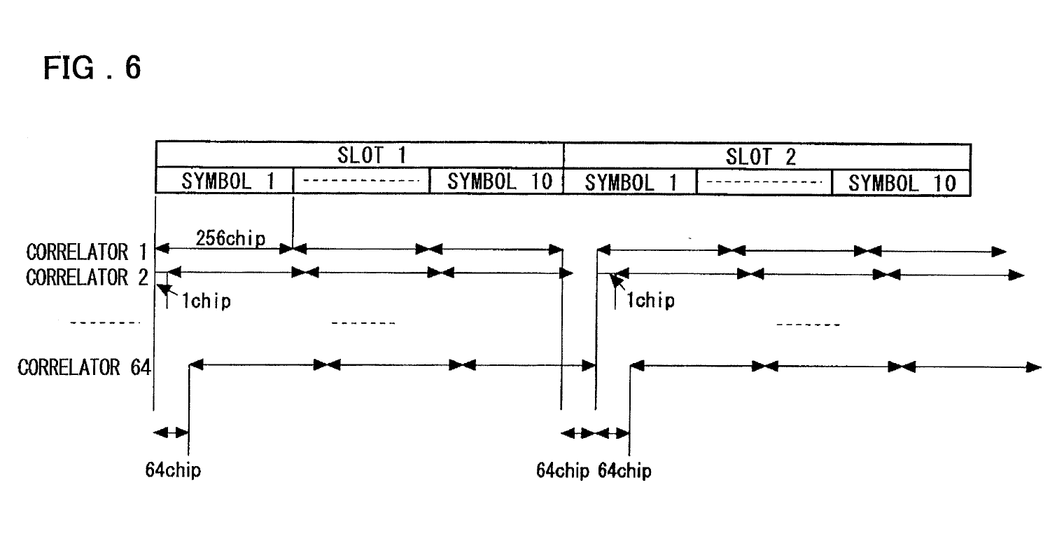

FIG. 6 is a diagram illustrating the operation timing of the correlating unit in Step 1 in accordance with the second embodiment of the present invention.

(1) The 64 correlators 1 to 64 provided in the correlating unit initiate operation chip by chip while each shifts the despreading position by one chip to thereby execute despreading over the duration of one symbol (256 chips) and output the results.

(2) The processing of (1) above is executed successively over the duration of one slot (10 symbols).

(3) After processing is halted for the duration of 64 chips, each of the correlators performs the same operation again.

(4) The processing of (1) to (3) above is executed over four slots, thereby completing despreading at 2560 chip positions. That is, in comparison with the case where there were ten slot timing candidates, correlator operation ends in half the number of slots.

Though the second embodiment has circuitry of a scale somewhat larger than that of the first embodiment, there is a higher probability that an “OK” decision will be rendered at step 2-3.

A third embodiment of the present invention will now be described. The basic structure of the third embodiment is similar to that of the first embodiment but the number of slot timing candidates detected in Step 1 is one on a per-symbol basis, for a total of five candidates.

Here the number of correlators in the correlating unit can be made 16. In this case, the operation of the detect unit 15 is such that slot timing candidates are all selected from even-numbered symbols if the symbol indicative of a maximum value is even-numbered and from odd-numbered symbols if the symbol indicative of a maximum value is odd-numbered.

In comparison with the first embodiment, the third embodiment results in a somewhat lower probability that an “OK” decision will be rendered at step 2-3 but makes it possible to reduce the scale of the circuitry.

The meritorious effects of the present invention are summarized as follows.

A first meritorious effect of the present invention is that the scale of the circuitry can be reduced.

The reason for this is that in the present invention, the correlator used in Step 2 (identification of frame timing) and in Step 3 (identification of scrambling code) in the conventional cell search circuit is shared in Step 1 (identification of slot timing), Step 2 (identification of frame timing) and Step 3 (identification of scrambling code) to implement the cell search. Thus the present invention dispenses with a matched filter. If the matched filter is a 256-stage filter, then 512 adders and a 512-word register can be eliminated for the I and Q components. The end result is that the circuitry can be reduced by about 15,000 gates.

A second meritorious effect of the present invention is that power consumption(an amount of electric current consumed) can be reduced by a sharp cut of the circuitry scale.

As many apparently widely different embodiments of the present invention can be made without departing from the spirit and scope thereof, it is to be understood that the invention is not limited to the specific embodiments thereof except as defined in the appended claims.

What is claimed is:

1. A cell search method for use in a CDMA (Code Division Multiple Access) mobile communications system comprising: a first step of identifying slot timing; a second step of identifying frame timing; and a third step of identifying a scrambling code, wherein:
a correlating unit executes despread processing utilizing a P-search code in the first step of identifying slot timing;
said correlating unit executes despread processing utilizing an S-search code in the second step of identifying frame timing; and
said correlating unit executes despread processing utilizing a P-scrambling code in the third step of identifying a scrambling code;
said correlating unit calculating correlation values in each of said first, second and third steps.

2. A cell search method for use in a CDMA (Code Division Multiple Access) mobile communications system comprising: a first step of identifying slot timing; a second step of identifying frame timing; and a third step of identifying a scrambling code, wherein:
calculation of correlation values in each of the first, second and third steps is performed by a correlating unit;
a plurality of slot timing candidates are detected at the first step of identifying slot timing without narrowing results of slot timing identification down to one candidate, said plurality of slot timing candidates being detected in one slot period by detecting one candidate, for which correlation power indicates a maximum value, at predetermined constant time intervals;
frame timing identification is performed with respect to all slot timing candidates in the second step of identifying frame timing based upon the plurality of slot timing candidates, and one frame timing candidate indicative of a maximum value is selected from among a plurality of candidates for frame timing; and
correlation power with regard to the one timing candidate selected at said second step is obtained and identification is achieved by rendering a threshold decision at said third step of identifying a scrambling code.

3. A cell search method in which a correlating unit receiving a baseband receive signal is provided with a code generator which generates a P-search code in a first step of identifying slot timing, an S-search code in a second step of identifying frame timing and a P-scrambling code in a third step of identifying a scrambling code, said correlating unit executing despread processing utilizing the P-search code in the first step, despread processing utilizing the S-search code in the second step and despread processing using the P-scrambling code in the third step;
a power calculating unit, which receives a correlation-value output from said correlating unit, performs a power calculation and stores correlation power in a memory;
a detect unit searches for a maximum value of correlation powers that have been stored in said memory in said first to third steps; and
a decision unit compares an average value of the correlation powers that have been stored in said memory with the maximum value, using a predetermined threshold coefficient, in said second and third steps;
wherein in said first step, said detect unit detects one slot timing candidate, which takes on a maximum value, over the duration of one symbol, and detects a plurality of slot timing candidates with regard to a plurality of symbols; and
in said second step, frame timing identification is performed with respect to all slot timing candidates based upon the plurality of slot timing candidates, and said detect unit selects one frame timing candidate indicative of a maximum value from among a plurality of candidates for frame timing.

4. The method as defined in claim 3, wherein said correlating unit creates a correlation power profile based upon the P-search code in said first step, said correlating unit being internally provided with a plurality of parallel-connected correlators which execute processing for starting operation chip by chip while each shifts a despreading position by one chip, executing despreading over the duration of one symbol and outputting the results, said processing being executing successively over one slot comprising a plurality of symbols;
after this processing is halted for the duration of a number of chips equivalent to the number of said plurality of correlators, processing similar to that of the preceding slot is executed again in the next slot;
said processing is executed over a predetermined plurality of slots, thereby completing despreading at a predetermined number of chip positions; and
when calculation of correlation values by said correlating unit and calculation of powers by said power calculating unit end and the correlation powers are written to said memory at all timings of chip positions of the predetermined number, said detect unit starts searching for a maximum value, detects one candidate, which takes on a maximum value, over the duration of one symbol, and detects a plurality of candidates with regard to a plurality of symbols.

5. The method as defined in claim 3, wherein in said second step, said correlating unit, which obtains a correlation value based upon the S-search code, has a plurality (2N) of correlators which operate upon being divided into first and second groups, the correlators in each group operating at identical timings;
the correlators of the first group perform despreading respectively by all codes of code numbers 1 to N in order, the correlators of the second group perform despreading respectively by all codes of code numbers 1 to N in order, the correlators of the first group perform despreading of odd-numbered symbols and output the results and the second group of correlators perform despreading of even-numbered symbols and output the results, with despreading being executed over the duration of one symbol; this processing is executed over a prescribed number of slots to thereby complete despreading, and when calculation of correlation powers by said correlating unit and said power calculating unit ends and the correlation powers are written to said memory at all timing candidates, said detect unit starts searching for a maximum value of correlation power and detects one candidate that takes on a maximum value; and
said decision unit evaluates the one candidate using an average of the power values that have been written to said memory, the maximum value and a predetermined threshold value.

6. The method as defined in claim 5, wherein said decision unit causes control to advance to said third step if the maximum value exceeds (threshold value)×(average value), and causes control to return to said first step if the maximum value does not exceed (threshold value)×(average value).

7. The method as defined in claim 6, wherein if a number of times said first step is restarted exceeds a number of times specified by a predetermined parameter, the cell search is judged to have failed and the cell search is terminated.

8. The method as defined in claim 3, wherein at said third step, a correlation power profile based upon the P-search code is created at the timing of the one candidate detected at said second step;
when calculation of correlation powers by said correlating unit and said power calculating unit ends and the correlation powers are written to said memory, said detect unit starts searching for a maximum value and detects one candidate that takes on a maximum value; and
said decision unit evaluates the one candidate using an average of the power values that have been written to said memory, the maximum value and a predetermined threshold value.

9. The method as defined in claim 3, wherein the cell search ends normally if the maximum value exceeds (threshold value)×(average value) and control is executed to return to said third step if the maximum value does not exceed (threshold value)×(average value).

10. The method as defined in claim 3, wherein said detect unit detects a plurality of slot timing candidates over the duration of one symbol instead of one slot timing candidate over the duration of one symbol in said first step.

11. The method as defined in claim 4, wherein said detect unit detects one slot timing candidate over the duration of a plurality of symbols instead of one slot timing candidate over the duration of one symbol in said first step.

12. The method as defined in claim 3, wherein said detect unit detects one slot timing candidate over the duration of a plurality of symbols instead of one slot timing candidate over the duration of one symbol in said first step.

13. The method as defined in claim 4, wherein said detect unit detects one slot timing candidate over the duration of a plurality of symbols instead of one slot timing candidate over the duration of one symbol in said first step.

14. An cell search apparatus comprising:
a correlating unit including:
a code generator which generates a P-search code in a first step of identifying slot timing, an S-search code in a second step of identifying frame timing and a P-scrambling code in a third step of identifying a scrambling code; and
a plurality of correlators arranged in parallel;
said correlating unit executing despread processing utilizing the P-search code in the first step, despread processing utilizing the S-search code in the second step and despread processing using the P-scrambling code in the third step;
a power calculating unit which calculates correlation power from the output of said correlating unit and outputs the calculated correlation power;
a memory which stores the output of said power calculating unit;
a detect unit which searches for a maximum value of correlation powers that have been stored in said memory in each of the first, second and third steps;
a decision unit which compares an average value of correlation powers that have been stored in said memory with the maximum value, using a predetermined threshold coefficient, in the second and third steps; and
a control unit which controls operation timing of each of the said units.

15. The apparatus as defined in claim 14, wherein said correlating unit creates a correlation power profile based upon the P-search code in said first step, a plurality of said correlators arranged in parallel in said correlating unit which respectively execute an operation for starting operation chip by chip while each shifts a despreading position by one chip, executing despreading over the duration of one symbol and outputting the results, said operation being executed successively over one slot comprising a plurality of symbols, and said correlators then halt the operation for the duration of a number of chips equivalent to the number of said plurality of correlators and subsequently execute processing similar to that of the preceding slot in the next slot;
said processing is executed over a predetermined plurality of slots, thereby completing despreading at a predetermined number of chip positions, and when calculation of correlation values by said correlating unit and calculation of powers by said power calculating unit end and the correlation powers are written to said memory at all timings of chip positions of the predetermined number, said detect unit starts searching for a maximum value, detects one candidate, which takes on a maximum value, over the duration of one symbol, and detects a plurality of candidates with regard to a plurality of symbols.

16. The apparatus as defined in claim 14, wherein at said second step, a correlation power profile based upon the P-search code is created at all timings of the plurality of candidates detected at said first step, said correlating unit has a plurality (2N) of correlators which operate upon being divided into first and second groups, the correlators in each group operating at identical timings;
the correlators of the first group perform despreading respectively by all codes of code numbers 1 to N in order, the correlators of the second group perform despreading respectively by all codes of code numbers 1 to N in order, the correlators of the first group perform despreading of odd-numbered symbols and output the results and the second group of correlators perform despreading of even-numbered symbols and output the results, with despreading being executed over the duration of one symbol;
this processing is executed over a prescribed number of slots to thereby complete despreading; and
when calculation of correlation values by said correlating unit and calculation of powers by said power calculating unit end and the correlation powers are written to said memory at all timings, said detect unit starts searching for a maximum value and detects one candidate that takes on a maximum value; and
said decision unit evaluates the candidate using an average of the power values that have been written to said memory, the maximum value and a predetermined threshold value.

17. The apparatus as defined in claim 16, further comprising means for exercising control in such a manner that control shifts to the processing of said third step if the maximum value exceeds (threshold value)×(average value), and processing from said first step is executed if the maximum value does not exceed (threshold value)×(average value).

18. The apparatus as defined in claim 16, further comprising means for exercising control in such a manner that if a number of times said first step is restarted exceeds a number of times specified by a predetermined parameter, the cell search is judged to have failed and the cell search is terminated.

19. The apparatus as defined in claim 17, further comprising means for exercising control in such a manner that if a number of times said first step is restarted exceeds a number of times specified by a predetermined parameter, the cell search is judged to have failed and the cell search is terminated.

20. The apparatus as defined in claim 14, wherein at said third step, said correlating unit creates a correlation power profile based upon the P-search code at the timing of the one candidate detected at said second step;
when calculation of correlation values by said correlating unit and calculation of powers by said power calculating unit end and the correlation powers are written to said memory, said detect unit starts searching for a maximum value and detects one candidate that takes on a maximum value; and
said decision unit evaluates the one candidate using an average of the power values that have been written to said memory, the maximum value and a predetermined threshold value.

21. The apparatus as defined in claim 20, further comprising means for exercising control in such a manner that the cell search ends normally if the maximum value exceeds (threshold value)×(average value) and control returns to said third step if the maximum value does not exceed (threshold value)×(average value).

22. The apparatus as defined in claim 14, wherein said detect unit is adapted to detect a plurality of slot timing candidates over the duration of one symbol in said first step.

23. The apparatus as defined in claim 15, wherein said detect unit is adapted to detect a plurality of slot timing candidates over the duration of one symbol in said first step.

24. The apparatus as defined in claim 14, wherein said detect unit is adapted to detect one slot timing candidate over the duration of a plurality of symbols in said first step and to detect a plurality of candidates in one slot.

25. The apparatus as defined in claim 15, wherein said detect unit is adapted to detect one slot timing candidate over the duration of a plurality of symbols in said first step and to detect a plurality of candidates in one slot.

26. A mobile terminal comprising the cell search apparatus as defined in claim 14.
